(19) United States
(12) Patent Application Publication
(10) Pub. No.: US 2006/0286999 A1
(43) Pub. Date: Dec. 21, 2006

(54) Wireless communication terminal with external mike sensing function and method thereof

(75) Inventor: Hyun-Jung Jeong, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech Co., Ltd.

(21) Appl. No.: 11/355,658

(22) Filed: Feb. 15, 2006

(30) Foreign Application Priority Data
Jun. 16, 2005 (KR) 10-2005-0051939

(51) Int. Cl. H04M 1/00

(52) U.S. Cl. 455/550.1

(57) ABSTRACT

Provided are a wireless communication terminal having an external mike sensing function and its method that determine an operation state of a wireless communication terminal's own mike by sensing an operation of an external mike depending on whether or not a mike signal sensing is issued from the external mike. The inventive wireless communication terminal includes a connection unit for generating a predetermined state level value when an earphone is connected, and receiving a mike sensing signal from the earphone, a voice input unit, a voice output unit, and a control unit for controlling an operation of each of the voice input unit and the voice output unit based on the predetermined state level value and the mike sensing signal from the connection unit.

### FIELD OF THE INVENTION

The present invention relates to a wireless communication terminal with an external mike sensing function and its method; more particularly to a wireless communication terminal with an external mike sensing function and a method thereof for determining an operation state of the terminal's own mike by sensing an operation of an external mike depending on whether or not a mike sensing signal is issued from the external mike.

### DESCRIPTION OF RELATED ART

A wireless communication terminal used herein refers to a terminal which is portable and capable of wireless communication such as a mobile communication terminal, a Personal Communication Service (PCS) terminal, a Personal Digital Assistant (PDA) terminal, a smart phone, a next generation mobile communication (IMT-2000) terminal, a wireless LAN terminal, or the like.

It is also assumed that an earphone used herein includes not only an earphone without a mike but also an earphone with a mike.

Meanwhile, the greatest merit of the wireless communication terminal among others is that it can provide its users with mobility. Due to such mobility, the number of wireless communication subscribers has been rapidly increased and in recent years the wireless communication terminals have been popularly utilized by the general public.

However, the merit of mobility to users of wireless communication terminals has been reduced gradually as time has passed; and instead, a multi-functional wireless communication terminal that can provide more various supplementary services has been required.

To meet such needs, most of the wireless communication terminals that are released recently have not only camera function but also other various supplementary functions such as radio broadcasting reception function, music (for instance, MP3: MPEG layer 3) reproduction function, finger-pressure function, blood sugar sensing function and ultrasound photographing function. In particular, the music reproduction function is one of most popular functions to young generation.

In the meantime, it is possible to listen to music through a wireless communication terminal's own speaker, but generally listen to music through an ear mike in consideration of other people nearby.

And as described early, when a telephone call is connected while listening to music through the ear mike, users tend to talk over the ear mike, rather than to pause the music reproduction and then talk over the wireless communication terminal's own speaker and mike.

The reason is that it is not possible to talk over the wireless communication terminal's own speaker and mike when the telephone call is connected under the state that the ear mike is inserted since the terminal's own speaker and mike stops its own function if the ear mike is inserted into the terminal.

On the other hand, recently an earphone exclusively for listening to music as well as an ear mike with a mike is used in order to listen to music through a wireless communication terminal. In case where such an earphone is used for listening to music as mentioned above, it is not possible to talk over a wireless communication terminal while the earphone is being plugged in because the earphone has no mike and the terminal's own mike doesn't operate due to the plugged-in ear mike. Thus, in such a case, it is necessary to disconnect the earphone from the wireless communication terminal in order to talk over the terminal.

In addition, in case where a mike of an ear mike is out of order, it is not possible to talk over a wireless communication terminal owing to the same reason as described early, thereby requiring a disconnection of the ear mike from the terminal and causing an inconvenience.

Consequently, it is required to prevent annoyance of a disconnection of the earphone from the wireless communication terminal in order to talk over the terminal by controlling a speaker and a mike of the terminal respectively when the earphone without a mike or an earphone whose mike is out of order is plugged in the terminal.

### SUMMARY OF THE INVENTION

It is, therefore, an object of the present invention to provide a wireless communication terminal with an external mike sensing function and its method for determining an operation state of the terminal's own mike by sensing an operation of an external mike depending on whether a mike sensing signal is issued from the external mike.

In accordance with one aspect of the present invention, there is provided a wireless communication terminal including: a connection unit for generating a predetermined state level value when an earphone is connected, and receiving a mike sensing signal from the earphone; a voice input unit; a voice output unit; and a control unit for controlling an operation of each of the voice input unit and the voice output unit based on the predetermined state level value and the mike sensing signal from the connection unit.

In accordance with another aspect of the present invention, there is provided a method for sensing an external mike in a wireless communication terminal including the steps of: (a) trying to connect an earphone; (b) receiving a predetermined state level value when the earphone is connected; (c) stopping of an operation of a voice output unit based on a predetermined state level value; and (d) stopping of an operation of a voice input unit when a mike sensing signal is inputted.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 is a block diagram of a wireless communication terminal with an external mike sensing function in accordance with one embodiment of the present invention; and

FIG. 2 is a flowchart describing a method for sensing an external mike in a wireless communication terminal in accordance with one embodiment of the present invention.

### DETAILED DESCRIPTION OF THE INVENTION

The above-mentioned objectives, features, and advantages will be more apparent from the following detailed description associated with the accompanying drawings; and based on this, the invention will be readily conceived by those skilled in the art to which the invention pertains. Further, in the following description, well-known arts will not be described in detail if it appears that they could obscure the invention in unnecessary detail. Hereinafter, a preferred embodiment of the present invention will be set forth in detail with reference to the accompanying drawings.

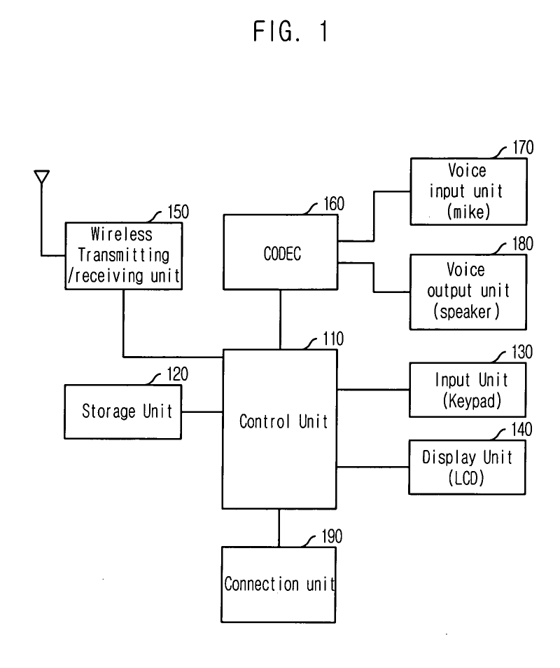

FIG. 1 is a block diagram of a wireless communication terminal having an external mike sensing function in accordance with one embodiment of the present invention.

As shown in FIG. 1, the wireless communication terminal having an external mike sensing function of the present invention includes a wireless transmitting/receiving unit 150 which transmits and receives a signal over a wireless communication network, a connection unit 190 physically connected to an earphone (not shown) which generates a state level value and receives a mike sensing signal from the earphone, a storage unit 120 which stores programs and file systems such as image, character and icon required for operating the wireless communication terminal, and a control unit 110 which controls an operation of a voice input unit (mike) 170 and a voice output unit (speaker) 180 based on the state level value of the earphone and the mike sensing signal transmitted from the connection unit 190. In addition, the inventive wireless communication terminal further includes an input unit (keypad) 130 for inputting menu selection information, etc., through a button, a display unit (LCD) 140 for providing a screen under the control of the control unit 110, a CODEC 160 which converts the signal transmitted from the wireless transmitting/receiving unit 150 into a voice by a control of the control unit 110 to output the voice to the voice output unit 180 and also converts a voice inputted from the voice input unit 170 into an electrical signal to transmit the signal to the control unit 110 which sends the same to the outside through the wireless transmitting/receiving unit 150, the voice output unit 180 for outputting the voice transmitted from the CODEC 160, and the voice input unit 170 for receiving the voice and transmitting it to the CODEC 160.

More specifically, stored in the storage unit 120 are operating programs and system programs of the control unit 110. These operating programs and system programs may be stored in an ordinary ROM embedded therein and also deleted when necessary. The storage unit 120 includes a RAM that temporarily stores various contents created while the operating programs are running.

The input unit 130 is provided with a multiplicity of numeral keys and character keys, menu keys, function keys which are used to conduct various functions, and so on, and outputs key data to the control unit 110 by an external control.

The connection unit 190 is physically connected to the earphone and generates a different state level value depending on whether the earphone is plugged in or not. For example, the connection unit 190 produces a high level value when the earphone is not plugged in and a low level value when the earphone is plugged in wherein a state level terminal is connected to the ground, and vice versa.

Further, the connection unit 190 receives a different mike sensing signal from the earphone. Here, the mike sensing signal is a signal that indicates whether the earphone is with or without a mike and whether a mike mounted in the earphone operates or not.

For instance, to find whether or not an earphone with a mike is plugged in and whether or not the mike of the earphone normally operates when the earphone with the mike is plugged in, the control unit 110 may request the user to input a test voice by displaying a message on the LCD 140 or request the user's voice for the test by outputting a voice through the voice output unit 180. Here, the test voice transmitted from the mike may be the mike sensing signal.

Thus, when the earphone has no mike, or a mike doesn't normally operate even though the earphone has the mike, it can be seen whether the earphone is with or without a mike and whether or not the mike mounted in the earphone operates based on the mike sensing signal since the test voice would not be transmitted through the mike in such a case.

Namely, when the test voice, i.e., the mike sensing signal is transmitted, it can be found that the mike is mounted in the earphone and the mike mounted in the earphone normally operates.

Meanwhile, the control unit 110 controls overall operations of the wireless communication terminal and each element involved therein. And also, the control unit 110 controls an operation of the voice output unit 180 in response to the state level value generated from the connection unit 190. As described above, when the connection unit 190 generates a low state level value, the control unit 110 detects that the earphone is plugged in through the connection unit 190 and thus stops an operation of the voice output unit 180.

In addition, the control unit 110 controls an operation of the voice input unit 170 depending on the mike sensing signal transmitted from the connection unit 190. As described early, transmitting the mike sensing signal through the connection unit 190 indicates that a mike that operates normally is mounted in an earphone inserted through the connection unit 190.

Thus, the control unit 110 stops an operation of the voice input unit 170 when it receives the mike sensing signal. Meanwhile, when the control unit 110 receives no mike sensing signal through the connection unit 190, it doesn't stop but continues an operation of the voice input unit 170.

As a result, it is possible to talk over through the wireless communication terminal even under the state that the user has inserted an earphone although the earphone without a mike or the earphone with a mike which is out of order is plugged in, by controlling the voice input unit 170 and the voice output unit 180 respectively based on the mike sensing signal and the state level value.

The display unit 140 is a display device such as a Liquid Crystal Display (LCD), or the like, which displays a current status of the wireless communication terminal or a progress status of the programs under the control of the control unit 110. That is to say, it displays an overall status of the wireless communication terminal, contents from the input unit 130, etc.

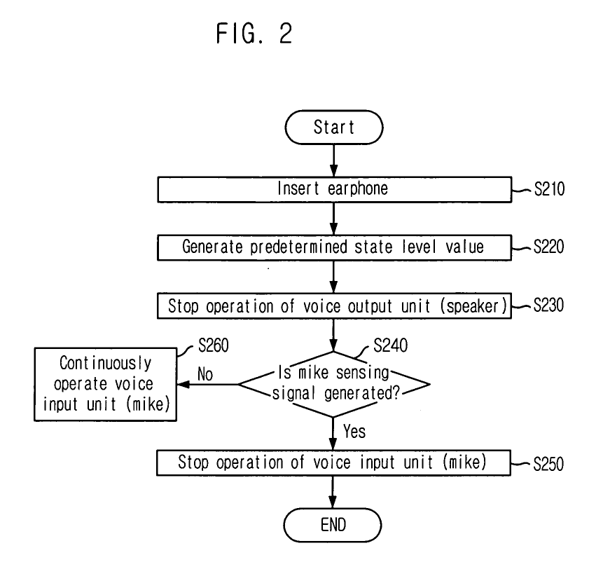

FIG. 2 is a flowchart describing a method for sensing an external mike in a wireless communication terminal in accordance with one embodiment of the present invention.

At a first step S210, an earphone is inserted through the connection unit 190. At a next step S220, as described early, when the earphone is inserted through the connection unit 190, a predetermined state level value is generated from the connection unit 190.

As stated previously, at step S230, when the predetermined state level value, e.g., a low value is generated, the control unit 110 stops an operation of the voice output unit 180 in the wireless communication terminal.

Thereafter, the control unit 110 checks at step S240 if a mike sensing signal is transmitted through the connection unit 190.

As a check result at said step S240, if the mike sensing signal is transmitted through the connection unit 190, at step S250, the control unit 110 senses that an earphone with a mike that operates normally is inserted and stops an operation of the voice input unit 170 in the wireless communication terminal.

In the meantime, as a check result at said step S240, if no mike sensing signal is transmitted through the connection unit 190, the control unit 110 senses that an earphone without a mike or an earphone with a mike which doesn't operate normally is inserted through the connection unit 190, and thus doesn't stop but continues an operation of the voice input unit 170 in the wireless communication terminal at step S260 so that it receives a voice through the voice input unit 170.

As a result, in case where an earphone without a mike or an earphone with a mike which doesn't operate normally is inserted, the wireless communication terminal of the present invention can allow a user to talk over the wireless communication terminal by controlling the voice input unit 170 and the voice output unit 180 respectively based on both of the state level value and the mike sensing signal through the connection unit 190, without any intentional disconnection of the earphone from the wireless communication terminal.

The method of the present invention as mentioned above may be implemented by a software program and stored in computer-readable storage medium such as CD-ROM, RAM, ROM, floppy disk, hard disk, optical magnetic disk, etc. This process may be readily carried out by those skilled in the art; and therefore, details of thereof are omitted here.

The present application contains subject matter related to Korean patent application No. 2005-0051939, filed with the Korean Intellectual Property Office on Jun. 16, 2005, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A wireless communication terminal with an external mike sensing function, comprising:
a connection unit for generating a predetermined state level value when an earphone is connected, and receiving a mike sensing signal from the earphone;
a voice input unit;
a voice output unit; and
a control unit for controlling an operation of each of the voice input unit and the voice output unit based on the predetermined state level value and the mike sensing signal from the connection unit.

2. The wireless communication terminal as recited in claim 1, wherein the state level value has a different value depending on whether the earphone is connected or not.

3. The wireless communication terminal as recited in claim 1, wherein the mike sensing signal has a different signal depending on whether or not the earphone is connected to a mike and whether or not the earphone operates.

4. A method for sensing an external mike in a wireless communication terminal, comprising the steps of:
(a) trying to connect an earphone;
(b) receiving a predetermined state level value when the earphone is connected;
(c) stopping an operation of a voice output unit based on the predetermined state level value; and
(d) stopping an operation of a voice input unit when a mike sensing signal is inputted.
